(19) United States
(12) Patent Application Publication
(10) Pub. No.: US 2018/0080542 A1
(43) Pub. Date: Mar. 22, 2018

(54) Gear Apparatus

(71) Applicant: TOYOTA JIDOSHA KABUSHIKI KAISHA, Toyota-shi (JP)

(72) Inventors: Masataka SUGIYAMA, Toyota-shi (JP); Yota MIZUNO, Nisshin-shi (JP)

(73) Assignee: TOYOTA JIDOSHA KABUSHIKI KAISHA, Toyota-shi (JP)

(21) Appl. No.: 15/700,602

(22) Filed: Sep. 11, 2017

(30) Foreign Application Priority Data
Sep. 20, 2016 (JP) 2016-183407

(51) Int. Cl. F16H 57/04; F16H 1/28; F16H 57/08

(52) U.S. Cl. CPC F16H 57/043; F16H 1/28; F16H 3/724; F16H 57/0471; F16H 57/0482; F16H 57/08

(57) ABSTRACT

A gear apparatus according to the present disclosure includes: a sun gear; a carrier to which planetary gear shafts rotatably supporting multiple planetary gears meshing with this sun gear are fixed; an external gear portion; a gear cylinder having an internal gear portion meshing with the planetary gears; a gear meshing with the external gear portion of the gear cylinder; a lubricating oil passage formed in the planetary gears shafts, the lubricating oil passage configured to supply the lubricating oil to respective mashing parts between the planetary gears and the internal gear portion and between the planetary gears and the sun gear; and a lubricating oil guiding passage having one end opening to an inner circumferential surface of the gear cylinder, and discharging the lubricating oil present on an inner circumferential surface of the gear cylinder toward the meshing part between the external gear portion and the gear.

### INCORPORATION BY REFERENCE

The disclosure of Japanese Patent Application No. 2016-183407 filed on Sep. 20, 2016 including the specification, drawings and abstract is incorporated herein by reference in its entirety.

### BACKGROUND

### 1. Technical Field

The present disclosure relates to a gear apparatus including a gear cylinder formed with an external gear portion and an internal gear portion, planetary gears meshing with the internal gear portion of this gear cylinder, and a gear meshing with the external gear portion of the gear cylinder.

### 2. Description of Related Art

In a vehicle including a transaxle-type power transmission mechanism in which a transmission and a differential unit, such as a speed change gear and a power distribution apparatus, are integrated, a scoop-up lubrication using a final reduction gear of a differential unit is common as a lubrication method for the power transmission mechanism. In this scoop-up lubrication, the differential unit is disposed to a lower end part of a transaxle case, and a lower end portion of the final reduction gear is set in a state of being soaked in a lubricating oil flowing into the lower end part of the transaxle case. Through this configuration, the lubricating oil is scooped up along with rotation of the final reduction gear so as to transfer the lubricating oil to respective meshing parts among gear elements composing the transmission.

Meanwhile, in a hybrid vehicle using both an engine and a rotary machine as motors, there has been known one using a planetary gear mechanism as a power distribution apparatus to split a motive power from the engine and a motive power from the rotary machine. In a vehicle including such a planetary gear mechanism, since a distance from the final reduction gear of the differential unit to the planetary gear mechanism is relatively far, a scoop-up lubrication does not work so effectively, so that a forced lubrication using an oil pump is employed, instead.

Japanese Patent Application Publication No. 2016-098909 discloses such a lubrication system, and a lubricating oil is supplied from a carrier side of a planetary gear mechanism to respective meshing parts between the planetary gear and a sun gear and between the planetary gear and an internal gear portion. In this JP 2016-098909 A, the final reduction gear of the differential unit meshes with a small gear of a secondary shaft. In addition, a large gear that is adjacent to this small gear and provided to the secondary shaft meshes with an external gear portion formed on an outer circumferential surface of a gear cylinder having an internal gear portion of the planetary gear mechanism formed on its inner circumferential surface, and also meshes with a gear integrally rotating with a rotor shaft of the rotary machine at the same time.

### SUMMARY

In a hybrid vehicle disclosed in Japanese Patent Application Publication No. 2016-098909, the lubricating oil supplied from the carrier side of the planetary gear mechanism to the respective meshing parts of the planetary gears with the sun gear and with the internal gear is guided to the inner circumferential surface of the gear cylinder by centrifugal force along with rotation of the gear cylinder. The lubricating oil is supplied from an oil discharge passage that opens to the inner circumferential surface and the outer circumferential surface of this gear cylinder to the small gear of the secondary shaft. In the meantime, a lubricating oil scooped up by the final reduction gear of the differential unit is supplied to the meshing part of this final reduction gear with the small gear. Hence, it is possible to sufficiently supply the lubricating oil to the small gear of the secondary shaft.

Unfortunately, it cannot be said that the lubricating oil is sufficiently supplied to the meshing part between the external gear portion of the gear cylinder of the planetary gear mechanism having a farther distance from the final reduction gear of the differential unit and the large gear that is adjacent to the small gear of the secondary shaft, and meshes with the external gear portion of the gear cylinder.

It can be considered that amount of the lubricating oil flowing into the lower end part of the transaxle case is increased so as to increase the supply amount of the lubricating oil to the aforementioned meshing part between the external gear portion of the gear cylinder of the planetary gear mechanism and the large gear of the secondary shaft. However, this method causes increase in energy loss to the final reduction gear of the differential unit due to increase in resistance to stirring resulting from the increase in amount of the lubricating oil.

The present disclosure provides a gear apparatus that can efficiently lubricate a meshing part between an external gear portion of a gear cylinder and a gear meshing with this external gear portion without increasing amount of the lubricating oil to be reserved in a transaxle.

A gear apparatus according to the present disclosure includes: a sun gear; a carrier disposed concentrically to the sun gear, the carrier to which multiple planetary gear shafts rotatably supporting respective multiple planetary gears meshing with the sun gear are fixed; a gear cylinder disposed concentrically to the sun gear in a manner as to surround the multiple planetary gears, the gear cylinder including an external gear portion, and an internal gear portion meshing with the multiple planetary gears; a gear meshing with the external gear portion; a lubricating oil passage formed in the planetary gear shafts, the lubricating oil passage configured to supply a lubricating oil to respective meshing parts between the planetary gears and the internal gear portion of the gear cylinder and between the planetary gears and the sun gear; and a lubricating oil guiding passage whose one end opens to an inner circumferential surface of the gear cylinder, the lubricating oil guiding passage guiding the lubricating oil present on the inner circumferential surface of the gear cylinder toward the meshing part between the external gear portion of the gear cylinder and the gear.

In the present disclosure, the lubricating oil flows through the lubricating oil passage formed in the planetary gears, and is supplied to the meshing parts between the planetary gears and the internal gear portion of the gear cylinder and between the planetary gears and the sun gear. The lubricating oil is then guided to the inner circumferential surface of the gear cylinder by centrifugal force, flows through the lubricating oil guiding passage whose one end opens to this inner circumferential surface, and is then supplied to the meshing part between the external gear portion of the gear cylinder and the gear.

In the gear apparatus of the present disclosure, the lubricating oil guiding passage can be defined by a communicating hole opening to the inner circumferential surface and an outer circumferential surface of the gear cylinder; and a tubular nozzle member whose base end is coupled to an opening portion of the communicating hole on the outer circumferential surface side of the gear cylinder, and whose front end opens toward the meshing part between the external gear portion of the gear cylinder and the gear.

There is further provided a pair of bearings disposed to both longitudinal ends of the inner circumferential surface of the gear cylinder so as to rotatably support the gear cylinder, and it is effective that an inner diameter of the inner circumferential surface of the gear cylinder between one bearing of the pair of bearings and the internal gear portion is set to be greater than an inner diameter of the inner circumferential surface of the gear cylinder between the other bearing of the pair of bearings and the internal gear portion, and one end of the lubricating oil guiding passage is set to open to the inner circumferential surface of the gear cylinder, the inner circumferential surface being located between the one of the bearings and the internal gear portion.

The lubricating oil can be supplied to the lubricating oil passage by using an oil pump.

According to the gear apparatus of the present disclosure, since the gear apparatus includes the lubricating oil guiding passage whose one end opens to the inner circumferential surface of the gear cylinder, the lubricating oil guiding passage discharging the lubricating oil present on the inner circumferential surface of the gear cylinder to the meshing part between the external gear portion of the gear cylinder and the gear, it is possible to guide the lubricating oil present on the inner circumferential surface of the gear cylinder to the meshing part between the external gear portion and the gear. As a result, it is possible to efficiently supply the lubricating oil to the meshing part between the external gear portion of the gear cylinder and the gear meshing with this external gear portion.

In the case of defining the lubricating oil guiding passage by coupling the base end of the tubular nozzle member to the opening portion of the outer circumferential surface of the gear cylinder, it is possible to discharge the lubricating oil to the meshing part between the external gear portion and the gear without forming the communicating hole to open to the external gear portion of the gear cylinder. As a result, it is possible to efficiently supply the lubricating oil to the meshing part between the external gear portion and the gear without causing deterioration of strength of the external gear portion.

In the case of setting the inner diameter of the inner circumferential surface of the gear cylinder between one of the bearings and the internal bearing portion to be greater than the inner diameter of the inner circumferential surface of the gear cylinder between the other of the bearings and the internal gear portion, and forming the one end of the lubricating oil guiding passage to open to this, it is possible to efficiently guide the lubricating oil flowing to the inner circumferential surface of the gear cylinder to the lubricating oil guiding passage.

In the case of supplying the lubricating oil to the lubricating oil passage by an oil pump, it is possible to surely supply the lubricating oil to the meshing part between the sun gear and the internal gear portion of the gear cylinder.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view showing a configuration outline of one embodiment in which a gear apparatus according to the present disclosure is installed in a hybrid vehicle;

FIG. 2 is a side view of a part of a transaxle case in the hybrid vehicle shown in FIG. 1; and

FIG. 3 is an extracted enlarged sectional view of a part of a planetary mechanism in FIG. 1.

### DETAILED DESCRIPTION OF EMBODIMENTS

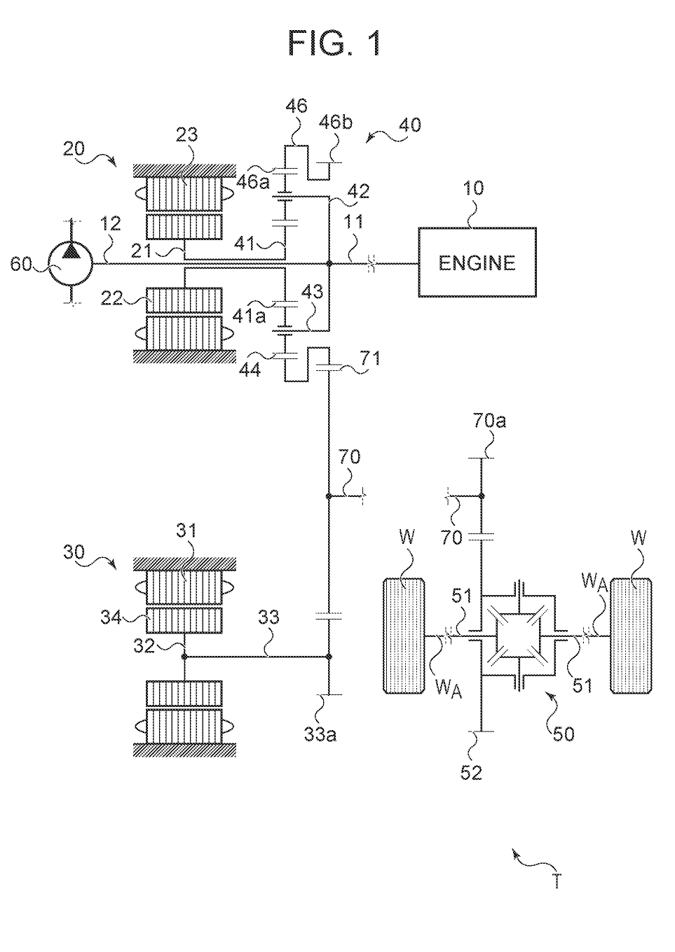

One embodiment of a gear apparatus according to the present disclosure applied to a hybrid vehicle will be described in detail with reference to FIG. 1 to FIG. 3. However, the present disclosure is not limited to such an embodiment, but is applicable to any gear apparatus belonging to the spirit of the present disclosure.

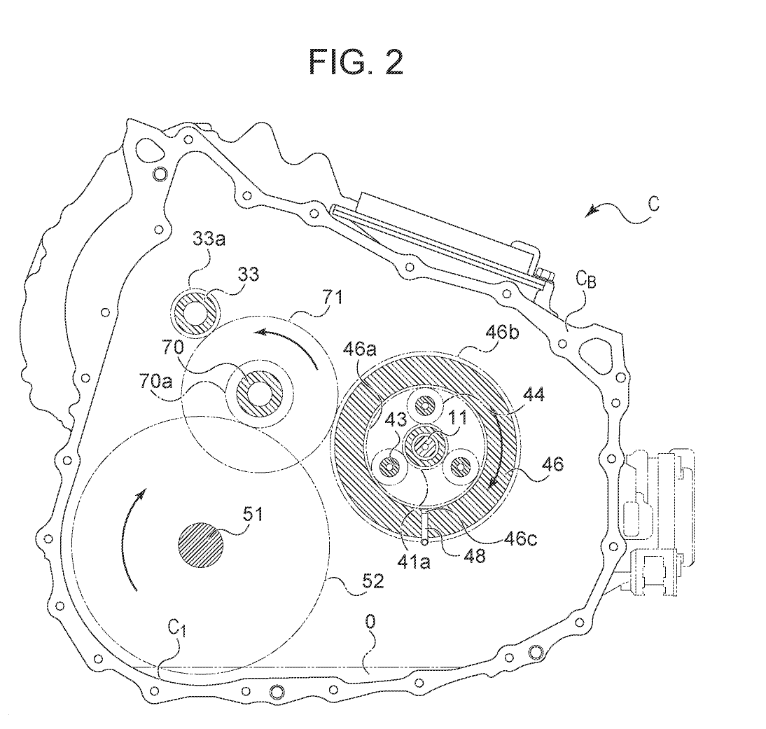

FIG. 1 shows a configuration outline of a hybrid vehicle in the present embodiment is schematically shown in FIG. 1, and FIG. 2 shows schematically a side shape of a housing part of the transaxle case.

The hybrid vehicle in the present embodiment includes one internal combustion engine, that is, an engine 10, a first electric rotary machine 20, and a second electric rotary machine 30, as motors; but the present disclosure is not limited to this. The present disclosure is applicable to a hybrid vehicle composed of one engine and one rotary machine as motors.

In the hybrid vehicle in the present embodiment, an EV mode in which only the electric rotary machines 20, 30 are operated with the engine 10 stopped and an HV mode in which the electric rotary machines 20, 30 and the engine 10 are both operated are switched from one to the other depending on the driving condition of the vehicle.

A power transmission system T including a planetary gear train 40 and a differential unit 50 is installed between the engine 10 and driven wheels W and between the two electric rotary machines 20, 30 and the driven wheels W. Axles W_{A} of the pair of right and left driven wheels W are coupled to a pair of right and left differential shafts 51 of the differential unit 50 protruding to the right side and the left side from side ends of a housing C_{A} and a casing C_{B} of a transaxle case C.

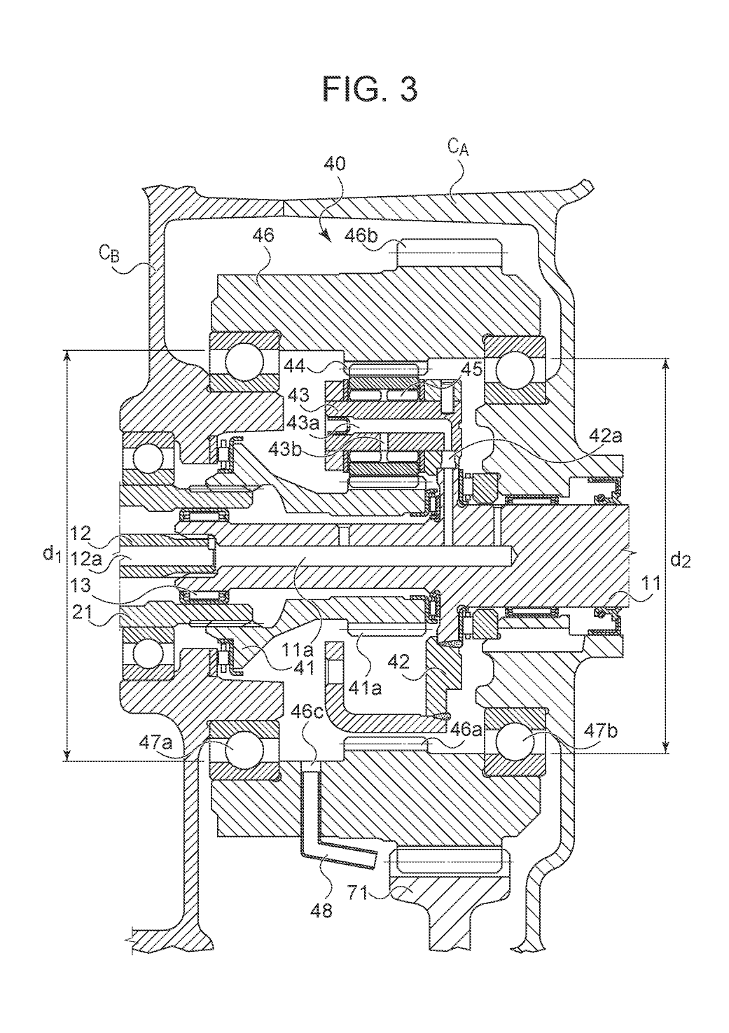

FIG. 3 shows an extracted and enlarged part of the planetary gear train 40 in FIG. 1 installed between the engine 10 and the first electric rotary machine 20. One end portion (the right side in FIG. 2) of an engine output shaft 11 is coupled via a not-shown torsional vibration damper to the engine 10. One end portion (the right side in FIG. 2) of a pump driving shaft 12 is spline-fitted to the other end portion of this engine output shaft 11, and a mechanical oil pump 60 is coupled to the other end portion of the pump driving shaft 12. This mechanical oil pump 60 is used for supplying a lubricating oil O to the power transmission system T and others, and is operated along with the engine 10.

The pump driving shaft 12 is formed with a lubricating oil supply passage 12a extending through the pump driving shaft 12 in a longitudinal direction thereof, and one end of this lubricating oil supply passage 12a communicates with a central oil passage 11a so formed as to extend from the other end of an engine output shaft 11 throughout a longitudinal central potion thereof. The lubricating oil O discharged from the mechanical oil pump 60 and a not-shown electric oil pump is supplied into the lubricating oil supply passage 12a.

A rotor 22 of the first electric rotary machine 20 is attached to a hollow rotor shaft 21 surrounding the pump driving shaft 12. A stator 23 of the first electric rotary machine 20, which surrounds this rotor 22, is fixed along with a stator 31 of the second electric rotary machine 30 to the casing C_{B} of the transaxle case C. Both ends of the rotor shaft 21 of the first electric rotary machine 20 are rotatably supported relative to the casing C_{B}, and the other end of the aforementioned pump driving shaft 12 is also rotatably supported relative to the casing C_{B}. One end of the engine output shaft 11 is rotatably supported relative to the housing C_{A} of the transaxle case C. A needle roller bearing 13 is installed between the other end of the engine output shaft 11 disposed into an inner side of one end (the right side in FIG. 2) of the rotor shaft 21 of the first electric rotary machine 20 and the rotor shaft 21 of the first electric rotary machine 20. Through this, the engine output shaft 11 is set in a state of being relatively rotatable with respect to the rotor shaft 21 of the first electric rotary machine 20.

One end (the right side in FIG. 3) of a hollow sun gear 41 disposed concentrically to the engine output shaft 11 in a manner as to surround the engine output shaft 11 is formed with a sun gear portion 41a, and the other end of this sun gear 41 is spline-fitted to one end of the rotor shaft 21 of the first electric rotary machine 20. Multiple planetary gear shafts 43 are fixed to a disk-shaped carrier 42 that is fixed to the engine output shaft 11 in a manner as to surround the sun gear portion 41a in parallel to a rotational axial line of the engine output shaft 11, and project from the carrier 42. Planetary gears 44 meshing with the sun gear portion 41a are rotatably supported to the respective planetary gear shafts 43 via needle roller bearings 45. An inner circumferential surface of the gear cylinder 46 disposed concentrically to the sun gear 41 in a manner as to surround these planetary gears 44 is formed with an internal gear portion 46a meshing with the planetary gears 44. Both longitudinal ends of the gear cylinder 46 is rotatably supported to the casing C_{B} and the housing C_{A} of the transaxle case C via a pair of ball bearings 47a, 47b, and an outer circumferential surface of the gear cylinder 46 is formed with an external gear portion 46b meshing with a large gear 71 of a secondary shaft 70.

The differential unit 50 is disposed to a lower end part of the transaxle case C in which the lubricating oil O is sealed, and the lubricating oil O flows down into an oil reservoir C₁ in the lower end part of the transaxle case C by gravity. When a vehicle is in a driving state, as indicated by a two-dot chain line in FIG. 2, amount of the lubricating oil O reserved in the transaxle case C may be set such that an entire part of the gear located at the lower most end of the final reduction gear 52 of the differential unit 50 is soaked in the lubricating oil O. Both ends of the secondary shaft 70 disposed above the differential unit 50 is rotatably supported by the housing C_{A} and the casing C_{B} of the transaxle case C. A large gear 71, which meshes with the external gear portion 46b of the gear cylinder 46 of the planetary gear train 40 and a small gear 33a of the motor output shaft 33 spline-fitted to a rotor shaft 32 of the second electric rotary machine 30 is fixed to one end (the right side in FIG. 2) of the secondary shaft 70. On the lateral side of the large gear 71 at the other end of the secondary shaft 70, there is formed an output gear 70a meshing with the final reduction gear 52 of the differential unit 50.

Further, the motor output shaft 33 is disposed above the secondary shaft 70, and is located substantially right above the differential unit 50. Relative to the differential unit 50, the aforementioned engine output shaft 11 is located more frontward than the secondary shaft 70, and is located further apart from the differential unit 50 than the secondary shaft 70 is. A distance from a rotary axial line of the final reduction gear 52 of the differential unit 50 to a rotary axial line of the external gear portion 46b of the gear cylinder 46 of the planetary gear train 40 is longer than a distance from a rotary axial line of the final reduction gear 52 of the differential unit 50 to a rotary axial line of the large gear 71 of the secondary shaft 70.

Meanwhile, the lubricating oil O in the oil reservoir C₁ is scooped up along with rotation of the final reduction gear 52 of the differential unit 50, and thus it is possible to supply the lubricating oil O to the output gear 70a of the secondary shaft 70 meshing with this final reduction gear 52.

However, it cannot be said that a sufficient amount of the lubricating oil O is supplied to the meshing part of the external gear portion 46b of the gear cylinder 46 having a farther distance from the final reduction gear 52 of the differential unit 50 with the large gear 71 of the secondary shaft 70. To cope with this, in the present embodiment, there is provided a tubular nozzle member 48, as will be described latter.

Each of the planetary gear shafts 43 is formed with a central oil passage 43a extending along a longitudinal direction thereof, and a radial oil passage 43b whose radially inner side communicates with this central oil passage 43a, and whose radially outer side opens to the outer circumferential surface of the planetary gear shaft 43 so as to supply the lubricating oil to the needle roller bearing 45. The carrier 42 is formed with a connecting oil passage 42a whose radially inner side communicates with an oil passage extending from the central oil passage 11a of the engine output shaft 11 in the radial direction, and whose radially outer side communicates with the central oil passages 43a of the planetary gear shafts 43. The central oil passage 43a and the radial oil passage 43b function as a lubricating oil passage of the present disclosure.

A portion of the gear cylinder 46, which is located between the internal gear portion 46a of the gear cylinder 46 of the planetary gear train 40 and the ball bearing 47a on one side, and is apart from a lateral end of the internal gear portion 46a of the gear cylinder 46, is formed with more than one communicating hole 46c opening to the inner circumferential surface and the outer circumferential surface of this gear cylinder 46. A tubular nozzle member 48 that guides the lubricating oil O flowing through the communicating hole 46c to the meshing part between the external gear portion 46b of the gear cylinder 46 and the large gear 71 of the secondary shaft 70 is coupled to the opening portion of the communicating hole 46c located on the outer circumferential surface side. A base end of the tubular nozzle member 48 is coupled to the opening portion on the outer circumferential surface side of the communicating hole 46c, and a front end portion thereof is bent toward the external gear portion 46b of the gear cylinder 46, and a front end thereof opens toward the meshing part between the external gear portion 46b and the large gear 71. Through this, the lubricating oil O present on the inner circumferential surface of the gear cylinder 46 is brought to be discharged toward the meshing part between the external gear portion 46b and the large gear 71.

Hence, the lubricating oil O flowing through the lubricating oil supply passage 12a of the pump driving shaft 12 flows from the central oil passage 11a of the engine output shaft 11 through the connecting oil passage 42a of the carrier 42, and is guided to the central oil passages 43a of the planetary gear shafts 43. The lubricating oil O is then supplied to the meshing parts of the needle roller bearings 45 disposed between the planetary gear shafts 43 and the planetary gears 44 and the planetary gears 44 with the internal gear portion 46a of the gear cylinder 46 and the sun gear 41. The lubricating oil O further flows along the inner circumferential surface of the gear cylinder 46 by centrifugal force, and lubricates the ball bearings 47a, 47b disposed between both ends of the gear cylinder 46, and the casing C_{B} and the housing C_{A}. At the same time, part of the lubricating oil O present on the inner circumferential surface of the gear cylinder 46 is supplied from the communicating hole 46c via the tubular nozzle member 48 to the meshing part between the external gear portion 46b and the large gear 71; and as a result, the lubricating oil O is also supplied to the small gear 33a of the motor output shaft 33 meshing with the large gear 71.

In this manner, the lubricating oil O guided from the communicating hole 46c to the external gear portion 46b of the gear cylinder 46 by the tubular nozzle member 48 is guided to the large gear 71 of the secondary shaft 70 and the small gear 33a of the motor output shaft 33. Eventually, the lubricating oil O flows down into the oil reservoir C₁ at the lower end part of the transaxle case C by gravity.

In the present embodiment, the lubricating oil guiding passage of the present disclosure is defined by the communicating hole 46c and the tubular nozzle member 48, but the communicating hole 46c may be configured to open to the external gear portion 46b of the gear cylinder 46, to thereby eliminate the tubular nozzle member 48. In this case, the lubricating oil guiding passage of the present disclosure may be defined by only the communicating hole 46c.

However, if an opening portion is formed to the external gear portion 46b of the gear cylinder 46 to which a great transmission torque is applied, deterioration of strength of the external gear portion 46b might be caused. In this respect, in the present embodiment, without configuring the communicating hole 46c to open to the external gear portion 46b of the gear cylinder 46, the lubricating oil O can be guided to the meshing part between the external gear portion 46b and the large gear 71, thus causing no deterioration of strength of the external gear portion 46b.

In such a manner that the lubricating oil O is discharged from the communicating hole 46c toward the meshing part between the external gear portion 46b of the gear cylinder 46 and the large gear 71, the communicating hole 46c may be inclined relative to the radial direction of the gear cylinder 46, to thereby eliminate the tubular nozzle member 48. In this case, the lubricating oil guiding passage of the present disclosure can be defined by only the communicating hole 46c.

In this manner, the lubricating oil O supplied to the planetary gear train 40 through a forced lubrication by the mechanical oil pump 60 and the electric oil pump can be guided to the meshing part between the external gear portion 46b of the gear cylinder 46 and the large gear 71 of the secondary shaft 70 via the communicating hole 46c and the tubular nozzle member 48. Through this configuration, it is possible to securely supply the lubricating oil O to the meshing part between the external gear portion 46b of the gear cylinder 46 and the large gear 71 of the secondary shaft 70. In addition, the amount of the lubricating oil reserved in the oil reservoir C₁ of the housing C_{A} is minimized so as to prevent increase in resistance to stirring of the lubricating oil O relative to the final reduction gear 52 of the differential unit 50.

In the present embodiment, the inner diameter d1 of the part of the gear cylinder 46, the part being located between the external gear portion 46b and the ball bearing 47a on one side is set to be greater than the inner diameter d₂ of the part of the gear cylinder 46, the part being located between the internal gear portion 46a and the ball bearing 47b on the other side. In this configuration, it is considered to guide a greater amount of the lubricating oil O from here to the communicating hole 46c.

It should be noted that the present disclosure should be interpreted based only upon matters described in the scope of claims, and in the aforementioned embodiments, all changes and modifications contained within the concept of the present disclosure can be made in addition to the matters described therein. That is, all the matters in the aforementioned embodiments are not elements for limiting the present disclosure and can change arbitrarily corresponding to the application and purpose, including constructions having no direct relation to the present disclosure.

The present disclosure may also be defined as follows. A gear apparatus includes: a sun gear; a plurality of planetary gears that mesh with the sun gear; a plurality of planetary gear shafts that rotatably support the plurality of planetary gears respectively; a carrier disposed concentrically to the sun gear, the carrier connected to the plurality of planetary gear shafts; a gear cylinder disposed concentrically to the sun gear such that the gear cylinder surrounds the plurality of planetary gears, the gear cylinder including an external gear portion, and an internal gear portion that meshes with the plurality of planetary gears; and a gear that meshes with the external gear portion, at least one of the plurality of planetary gear shafts including a lubricating oil passage configured to supply a lubricating oil to a meshing part between the plurality of planetary gears and the internal gear portion, and to a meshing part between the plurality of planetary gears and the sun gear, and the gear cylinder including a lubricating oil guiding passage that has an opening communicated to an inner circumferential surface of the gear cylinder at one end of the lubricating oil guiding passage, the lubricating oil guiding passage configured to discharge the lubricating oil present on the inner circumferential surface of the gear cylinder toward the meshing part between the external gear portion and the gear. The lubricating oil guiding passage may include: a communicating hole opening to an inner circumferential surface and an outer circumferential surface of the gear cylinder; and a tubular nozzle member configured such that a base end of the tubular nozzle member is coupled to an opening portion of the communicating hole on an outer circumferential surface of the gear cylinder, and a front end of the tubular nozzle member opens toward the meshing part between the external gear portion of the gear cylinder and the gear. The gear apparatus may further includes a pair of bearings disposed to both ends of the inner circumferential surface of the gear cylinder in a longitudinal direction of the gear cylinder such that the pair of bearings rotatably support the gear cylinder. The pair of bearings may be configured such that an inner diameter of the inner circumferential surface of the gear cylinder between one of the pair of bearings and the internal gear portion is greater than an inner diameter of the inner circumferential surface of the gear cylinder between the other one of the pair of bearings and the internal gear portion, and the one end of the lubricating oil guiding passage may open to the inner circumferential surface of the gear cylinder, the inner circumferential surface being located between the one of the pair of bearings and the internal gear portion. The gear apparatus may be configured such that the lubricating oil is supplied to the lubricating oil passage by an oil pump.

What is claimed is:

1. A gear apparatus comprising:
a sun gear;
a plurality of planetary gears that mesh with the sun gear;
a plurality of planetary gear shafts that rotatably support the plurality of planetary gears respectively;
a carrier disposed concentrically to the sun gear, the carrier connected to the plurality of planetary gear shafts;
a gear cylinder disposed concentrically to the sun gear such that the gear cylinder surrounds the plurality of planetary gears, the gear cylinder including an external gear portion, and an internal gear portion that meshes with the plurality of planetary gears; and
a first gear that meshes with the external gear portion,
at least one of the plurality of planetary gear shafts including a lubricating oil passage configured to supply a lubricating oil to a meshing part between the plurality of planetary gears and the internal gear portion, and to a meshing part between the plurality of planetary gears and the sun gear, and
the gear cylinder including a lubricating oil guiding passage that has an opening communicated to an inner circumferential surface of the gear cylinder at one end of the lubricating oil guiding passage, the lubricating oil guiding passage configured to discharge the lubricating oil present on the inner circumferential surface of the gear cylinder toward a meshing part between the external gear portion and the first gear.

2. The gear apparatus according to claim 1, wherein
the lubricating oil guiding passage includes:
a communicating hole opening to an inner circumferential surface and an outer circumferential surface of the gear cylinder; and
a tubular nozzle member configured such that a base end of the tubular nozzle member is coupled to an opening portion of the communicating hole on an outer circumferential surface of the gear cylinder, and a front end of the tubular nozzle member opens toward the meshing part between the external gear portion of the gear cylinder and the gear.

3. The gear apparatus according to claim 1, further comprising
a pair of bearings disposed to both ends of the inner circumferential surface of the gear cylinder in a longitudinal direction of the gear cylinder such that the pair of bearings rotatably support the gear cylinder, wherein
the pair of bearings is configured such that an inner diameter of the inner circumferential surface of the gear cylinder between one of the pair of bearings and the internal gear portion is greater than an inner diameter of the inner circumferential surface of the gear cylinder between the other one of the pair of bearings and the internal gear portion, and
the one end of the lubricating oil guiding passage opens to the inner circumferential surface of the gear cylinder, the inner circumferential surface being located between the one of the pair of bearings and the internal gear portion.

4. The gear apparatus according to claim 1, wherein
the gear apparatus is configured such that the lubricating oil is supplied to the lubricating oil passage by an oil pump.
